(19) United States
(12) Patent Application Publication
(10) Pub. No.: US 2003/0028465 A1
(43) Pub. Date: Feb. 6, 2003

(54) Method and system for providing professional assistance to participants in an investment plan

(76) Inventor: Bruce C. Kosinski, Highland Beach, FL (US)

Correspondence Address: SQUIRE, SANDERS & DEMPSEY L.L.P., Two Renaissance Square, Suite 2700, 40 North Central Avenue, Phoenix, AZ, 85004-4498, US

(21) Appl. No.: 10/197,086

(22) Filed: Jul. 16, 2002

Related U.S. Application Data
(60) Provisional application No. 60/305,670, filed on Jul. 16, 2001.

(51) Int. Cl. G06F 17/60

(52) U.S. Cl. 705/36

(57) ABSTRACT

A system for facilitating investments portfolio modeling in an investment fund is disclosed. The system includes a computer that is operable to receive demographic information about a participant in an investment program, the information is provided to an investment advisor who determines a proposed portfolio based on a pre-existing portfolio or, if there is no pre-existing portfolio, based on other factors. The proposed portfolio is sent to the participant.

### RELATED APPLICATIONS

This application claims priority to provisional patent application 60/305,670 under 35 U.S.C. § 119(e)(1), which is hereby incorporated by reference for all purposes.

### TECHNICAL FIELD

This invention relates to financial planning and particularly a method and system for assisting participants in an investment plan.

### BACKGROUND OF THE INVENTION

Employees of educational organizations of state and local government as well as employees of certain tax-exempt organizations under 501(c)(3) of the internal revenue codes can elect to defer a portion of their salaries for retirement in a 403(b) plan. 403(b) plans are also known as Tax-Sheltered Annuities or TSAs because originally the funds of such plans could only be invested in Tax-Sheltered Annuities. Under a 403(b) plan an employee is eligible to set aside a certain portion of their pay on a pre-tax basis. The earnings of the 403(b) plan are free from taxation until they are withdrawn. There are however, penalties for early withdrawals. A participant in a 403(b) plan can have their funds invested in annuities (fixed or variable) or mutual funds. Annuities have a death benefit component that mutual funds do not have. A provider of variable annuities or mutual funds typically offers several different investment vehicles that vary in potential risk and potential returns.

One drawback of 403(b) is the lack of assistance provided to individual participants in a 403(b) program. This is due to several factors. One factor is that typically a school district or other organization may have several dozen different authorized investment providers. The shear number of choices makes it difficult for a participant to research funds and annuities. Complicating the matter is the fact that in order to keep a plan not subject to the Employee Retirement Income Security Act of 1974 (ERISA), the employers can not contribute to the plan and can not exert too much influence in the administration of the plan or the investment selection. Thus, the participant is left with a wide range of investment options, and little resources to evaluate them.

### SUMMARY OF INVENTION

Thus, a need has arisen for an investment portfolio modeling tool that overcomes the disadvantages and drawbacks of current investment assistance schemes.

In one embodiment a method for facilitating investments is disclosed. In a first step, information concerning participants is received. Next, the current investment strategy of the participants is reviewed. A new proposed investment portfolio is formulated and sent to each participant.

The method optionally includes other steps such as receiving a request from the participant to reasearch the proposed portfolio, comparing a proposed portfolio's risk factor with a participant's risk profile; and processing a buy request from the participant.

A system for facilitating investments is disclosed. The system comprises a computer operable to receive demographic information about a participant in an investment program. The demographic information is provided to an investment advisor who formulates a proper investment portfolio. The investment portfolio is sent to the participant.

Technical benefits of the present invention include the ability to allow for a participant to receive advice from an investment advisor. Additionally, by taking in to account the risk acceptance of the partcipant and the risk level of the investments, an investor will be able to make decisions regarding investments with a greater comfort level.

### BRIEF DESCRIPTION OF THE DRAWINGS

Non-limiting and non-exhaustive preferred embodiments of the present invention are described with references to the following figures wherein like reference numerals refer to like parts throughout the various views unless otherwise specified.

FIG. 1 is a block diagram of the computer system for facilitating investment portfolio management in accordance with the teachings of the present invention;

FIG. 2 is a block diagram of an investment web site;

FIG. 3 is a flow chart outlining the acquisition of data for the present invention;

FIG. 4 is a flow chart outlining the acquisition of financial data in the present invention;

FIG. 5 is a flow chart outlining the activation of a participant;

FIG. 6 is a flowchart illustrating a participant's use of the present invention;

FIG. 7 is an exemplary view of the current investment screen;

FIG. 8 is an exemplary change investment screen;

FIG. 9 is an exemplary process change screen;

FIG. 10 is an exemplary change future allocation screen;

FIG. 11 is a buy confirmation screen;

FIG. 12 is a change to account screen;

FIG. 13 is a pending trade screen;

FIG. 14 is a transaction detail screen;

FIG. 15 is a flow chart illustrating the professional choice module;

FIG. 16 is a professional choice proposed model;

FIG. 17 is a professional choice proposed future allocation module;

FIG. 18 is a screen to send messages to an advisor;

FIG. 19 is an administrator back end screen; and

FIG. 20 is a pip/portfolio risk warning screen.

### DETAILED DESCRIPTION OF THE PREFERRED EMBODIMENTS

Turning first to the nomenclature of the specification, the detailed description that follows is represented largely in terms of processes and symbolic representations of operations by conventional computer components, including a central processing unit (“CPU”) or processor associated with a general purpose computer system, memory storage devices for the CPU, and connected pixel-oriented display devices. These operations include the manipulation of data bits by the CPU and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this discussion, a process or method is generally considered to be a sequence of computer-executed steps, or a combination of computer executed steps and manual steps leading to a desired result. Each of these steps generally requires inputting information, storing information or manipulations of physical quantities. Usually, although not necessarily, these quantities take the form of electrical, magnetic, or optical signals capable of being stored, transferred, combined, compared or otherwise manipulated. They can be stored and distributed on a computer readable medium. It is conventional for those skilled in the art to refer to these signals as bits, values, elements, symbols, characters, text, terms, numbers, records, files, or the like. It should be kept in mind, however, that these and others should be associated with appropriate physical quantities for computer operations, and that these terms are merely conventional labels applied to physical quantities that exist within and during operation of the computer.

In addition, it should be understood that the programs, processes, methods, etc. described herein are but an example of one preferred embodiment of the present invention and are not related or limited to any particular computer, apparatus or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hardwired logic or programs stored in non-volatile memory, such as read-only memory. Although described in a client server environment, that structure is for exemplary purposes only. It is understood that processes, data and other functionality can be located at a single server or distributed over a series of computers in communications with each other.

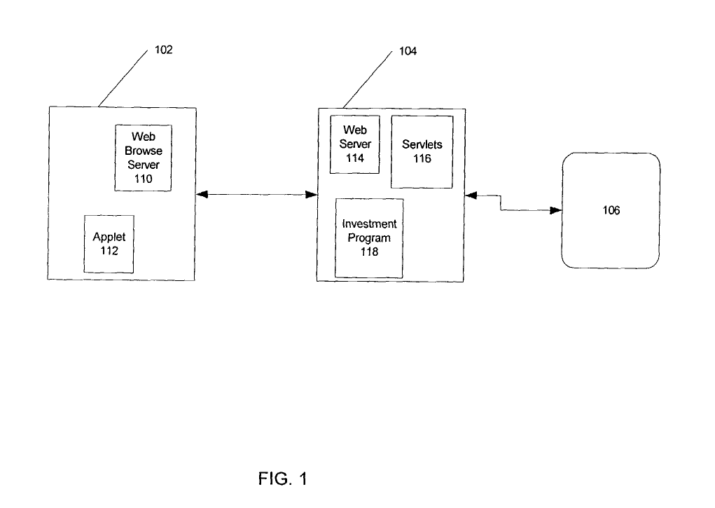

FIG. 1 is a block diagram of an embodiment of the system for facilitating 403(b) investments utilizing a client/server computer system 100. Illustrated is a client computer 102 coupled to a server 104. Server 104 is, in turn, connected to an investment database 106.

Client computer 102 can be any computing device capable of accessing other computers in a networked environment including a personal computer, a hand held computer, a personal digital assistant and the like. Client computer 102 is preferably a personal computer having a processor, a printer, an input device such as a keyboard and/or mouse, a monitor, a floppy disk drive, memory, a modem and/or computer network interface, and a mass storage device such as a hard disk drive and/or a CD-ROM drive. Client computer 102 operates under the control of an operating system such as MS-DOS, WINDOWS OS, OS/2, UNIX, LINUX, MAC OS and the like. In one embodiment, client computer 102 is operable to run a web browser.

Web browser program 110 is operable to communicate with server 104 using a protocol such as HTTP. Web browser program 110 is operable to receive information in a mark-up language such as HTML from a server 104 and output a formatted display. Web browser program 110 allows a user to enter the web address or uniform resource locator (URL) of an Intranet, Extranet, or Internet page will retrieve information from server 104 and display the information on client computer 102. In the present invention, the user of client computer 102 will utilize the web browser program 110 on client computer 102 to research investments, manage an investment account such as a 403(b) account and buy and sell investments in an investment account such as a 403(b) account. The user typically enters the URL of a home page where the initial web page is stored and navigates through other web pages of the web site. Web browser program 110 may also be a script enabled browser that is able to run scripting languages such as JavaScript to enhance the browser display by helping to draw user interfaces and making displays that are responsive to user interaction. Web browser program 110 is also able to execute dynamic HTML pages, which can be updated automatically.

An applet 112 may also run in conjunction with web browser program 110. An applet is a module of code, such as JAVA code that runs in conjunction with web browser program 110 to enhance the web browser program 110 functionality or to add content to web browser program 110. In the present invention, applet 112 can be used for compressing/decompressing and encrypting/unencrypting information sent to and received from server 104. Applet 112 can also sort data, keep track and format data returned from web server 104. Applet 112 functionality may be, in large part replaced by a similarly functioning servlet executed at the server 104. However, it is often more efficient to provide a client side applet.

Server 104 is a computer, such as a personal computer, file server, work station, minicomputer, main frame, or any other computer capable of communicating and interconnecting with other computers. Server 104 will preferably include a processor, an input-device such as a mouse and/or keyboard, a monitor, memory, a modem or other means of communicating with other computers, a mass storage device such as a hard disk drive or optical disk drive and a floppy disk drive. Server 104 will operate under the control of an operating system such as Windows OS, Unix, Linux, Macintosh OS and the like. A communication line 103 couples client computer 102 with server 104. Communication line 103 may be any type of communication link capable of supporting data transfer. For example, these communication lines may include any combination of an integrated service digital network (ISDN) communication line, a hard wired line, a telephone link, a digital subscriber line, a cable connection, a fiber optic link, or a wireless connection. Communication line 103 will support the transfer of an HTTP stream between client computer 102 and server 104. The HTTP stream maybe compressed for efficiency purposes and encrypted for security purposes. While server 104 is shown as a single computer, the functionality and data storage can be distributed throughout one or more computers in communication with each other.

In one embodiment, a web server application 114 will be running on the server 104. Web server 104 is operable to host a web site. The type of web server application 114 depends upon the operating system running on the server 104. For example, if the server 104 is running a UNIX operating system, the web server application 114 may be an Apache web server application.

One or more servlets 116 may also be running under the web server application 114. Servlet 116 is a module of code, typically JAVA code that runs in conjunction with the server application to answer client requests. These can be contrasted with applets, which run on the client computer 102. In the present invention, servlets 116 assists in returning the results of a database query to the server 104 and client computer 102, as well as validate user security, compress and encrypt data and perform other functions to assist the web application 114 in sending information back to the web browser.

Coupled to the server 104 is the investment database 106. The investment database 106 holds information such as information regarding investment vehicles including historical performance and relative risk as well as information regarding participants such as census data and the conservative/aggressive investment nature of the participant. The information may be provided in a single database or multiple databases.

Server 104 can access investment database 106 directly or by using a middleware application such as Java Database Cartridge or an Oracle Database Cartridge made by ORACLE. Alternatively, an extensible mark-up language (XML) database can be used along with an XML parser to select database entries from investment database 106. The exact method of accessing databases is a design choice that can be varied by one skilled in the art.

An investment web site 118 is also running under web application 114. Investment web site 118 is operable to provide current investment information as well as possible different investment vehicles to a participant in an investment plan such as a 403(b) plan using client computer 102. Investment web site 118 receives investment data as well as participant data from database 106 and formulates investment risk ratings and provides investment research information. Client computer 102 searches this information. The investment web site 118 is discussed in further detail below.

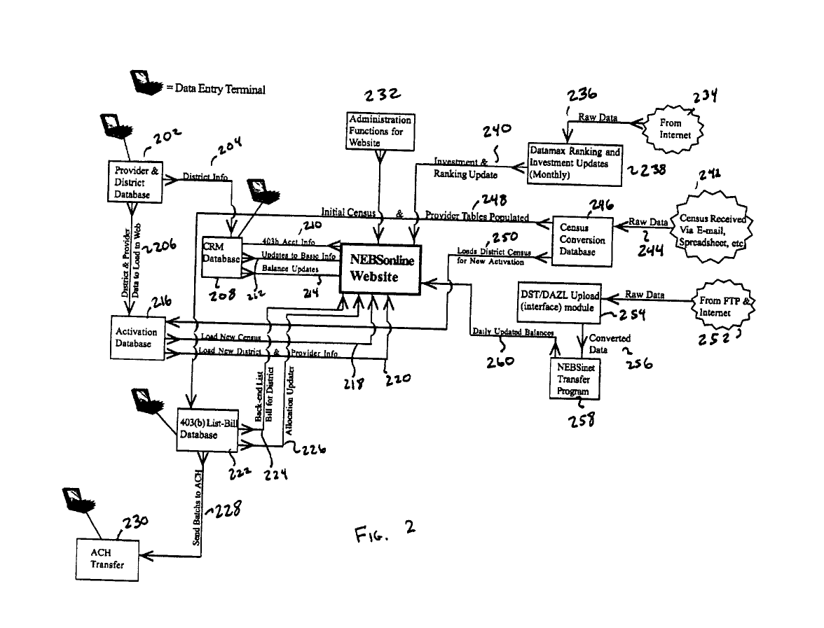

FIG. 2 is a block diagram of an investor web site 118 including the database and modules that support the investor web site 118. In one embodiment the investment web site 118 is a 403(b) investment web site although other types of investments may also be purchased and researched at such a web site. Illustrated is investor web site 118. A customer relationship management (CRM) database 208, an activation database 216, a list-bill database 222, a financial data ranking and investment update database 236, a transfer program 258 and an administrative back end 232 are coupled to web site 118. In one embodiment, web site 118 is accessible by a client computer that has access to the Internet. Web site 118 can also be provided on an Intranet or private network or even on a stand alone (non-networked) computer such as a stand-alone kiosk.

CRM database 208 receives organization information 204 from a provider/organization database 202. The CRM database provides basic information updates 212 and balance updates 214 to investment web sites. Balance updates 214 update the investment web site with information regarding a participant's investment balance. The CRM database also receives account information from the investment web site 118.

Activation database 216 receives district census 250 from a census conversion database 246. District census 250 is provided by the employer and includes information such as a participant's name, contact information and existing investment information, if any. This information is used to initially activate a user into the investment web site 104. The census conversion database 246 receives this census information as raw data 244 from the organization or other source. Activation database 216 also receives district and provider data 206 from the provider and district database 202. The district and provider data 206 contains information such as the name and contact information for approved financial vendors, organizational information and the like. The activation database 216 provides information such as new census data 218 and organization/provider data 220 that are provided to investment web site 118. Census data 218 includes information regarding participants in an investment plan such as an organization 403(b) plan. Organization/provider data 220 provides information regarding an organization offering the investment plan and the investment providers approved under the plan.

List-bill database 222 receives populated census and provider tables 248 from census conversion database. List-bill database 222 outputs a back-end list-bill 224 and an allocation updater 226 to investment web site 118. List-bill database also send batch information regarding the purchase of investment vehicles to an automatic clearing house transfer 230. This allows for electronic payment for investment vehicles purchased.

Data ranking and investment update database 236 receives raw data regarding the investment vehicles offered by the authorized investment providers. This information can be obtained from a third party investment information company such as National Datamax, Inc. This information is sorted and formatted and the individual investment vehicles are ranked on a conservative to aggressive scale. This information is sent as investment and ranking data 240 to investment web site 118.

Transfer program 258 receives converted data 256 from an upload module 254 that receives raw data 253 via the Internet file transfer protocol or other means. This raw data includes investment fund and account information concerning participants' in an organization's investment plan such as a 403(b) plan. The raw data 253 is uploaded by module 254 which sends the converted data to a transfer program 258 to provide updated daily balances to web site 104. The raw data is provided by a third party financial information provider such as DST Systems of Kansas City, Mo. and DAZL of Westborough, Mass.

Administration function 232 allows the web site administrator to access the investment web site 118 for design, maintenance and other functions. The databases shown in FIG. 2 can be provided as a single database or multiple databases.

Initial Data Acquisition

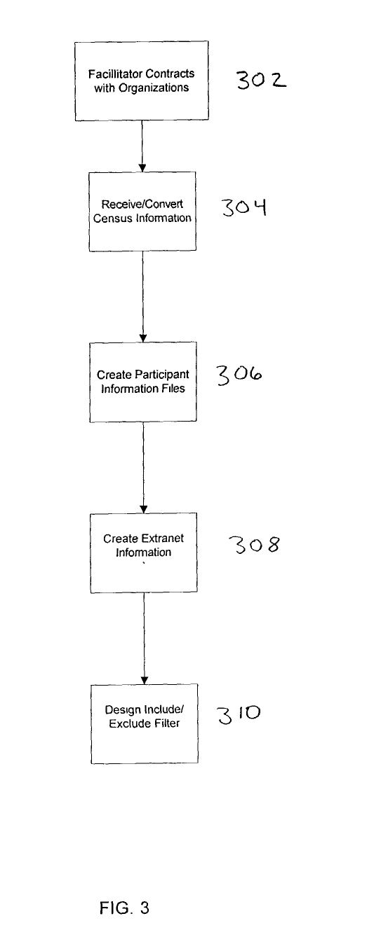

FIG. 3 is a flow chart illustrating the acquisition of data for the present invention. In a first step 302 a facilitator contracts with an organization offering an investment program to its employees, such as a public school system offering a 403(b) plan. The facilitator is distinct from the investment provider in that a facilitator does not itself offer investment vehicles such as annuities and mutual funds. Instead, the facilitator offers information regarding all investment vehicles offered by all providers that are certified for a specific organization, as well as offering investment advice. The facilitator may also be a broker/dealer in investments authorized by the participants to buy and sell investments.

In step 304, the facilitator receives census information from the organization with which it has a contract. This census information includes data on all employees eligible to participate in the investment plan. This data may include employee's social security number, birth date and year, the name of the provider the employee currently uses to invest, the employee's current portfolio, and the investment providers used to invest future investment dollars.

The demographic information is then used to make individual participant information files in step 306. Each individual participant in the organization's investment plan will have a file with the individual's demographic information stored therein.

In step 308, the facilitator creates an extranet that the participants in the organization's investment program can access. An extranet is an Internet web site that is hosted by a third party for use by members of an organization. The extranet will contain information such as a list of qualified investment providers, a newsletter, as well as links to the facilitator's web site.

In step 310, filters are design to exclude or include certain investment choices. This is needed because a facilitator may have investment listings for investment providers that are not an approved provider for a particular organization. Also, a provider may have investment vehicles that are not approved for the participants in an organization's investment plan. In these cases, the search filter would be needed to exclude these investment choices.

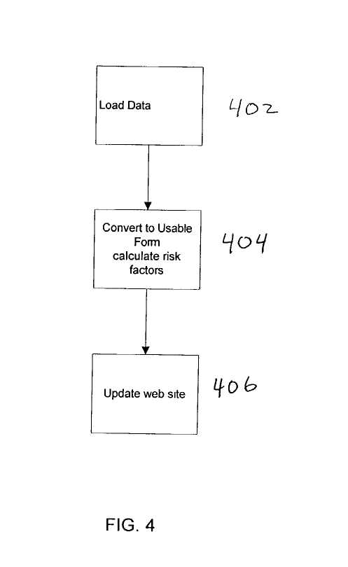

Another part of the initial data acquisition is the initial acquisition of the identity of the investment vehicles that are authorized and the corresponding research data. This is illustrated in FIG. 4. In step 402, data such as the financial vehicles offered by the providers and research data including such information as year to date performance, historical performance, loan information and the like regarding financial vehicle are loaded into the system. This information is converted into a form useable by the investment web site 118. In step 404 a risk factor for each investment vehicle is calculated by the facilitator or provided by a third party. The risk factor for each investment vehicle such as a mutual fund or an annuity is based on several factors such as how the price of the investment vehicle responds to market forces, amount of return independent of the market, how much variability there is in the stock is based on returns on the market, the overall objective of the investment vehicles, the portfolio composition of the investment vehicles and the variation of an investment vehicle's return around an asset's average or expected return. In one embodiment, each investment vehicle is given a rating of 100 to 500 with 100 indicating a conservative investment vehicle and 500 representing an aggressive investment vehicle. The risk factor information is updated as needed. Typically the information is updated on a monthly basis although more or less frequent updates are possible.

In step 406, the information is used to update the risk ratings and to produce new monthly investment performance data. This information is uploaded to the facilitator's database for use by participant in searching for an investment vehicle at the investment web site 118.

End User Activation Process

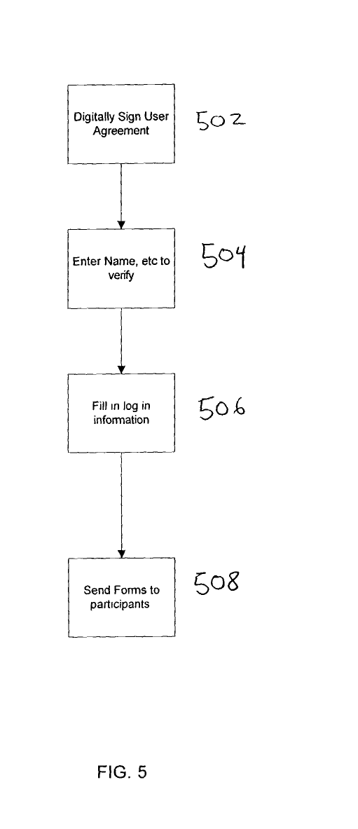

FIG. 5 is a flow chart illustrating the activation of a participant in the facilitator's web site in accordance with the teachings of the present invention. In step 502, the participant accesses the facilitator's web site and provides a digital signature to indicate acceptance of a user agreement. This can be in the form of clicking on an icon indicating acceptance after reading through the user agreement or in any other agreed upon or legally required way to enact a digital signature. In step 504, the participant enters their first name, last name and birth date which is then checked against the organization's database to see if it matches the file created in the initial data acquisition phase as discussed in conjunction with FIG. 3, step 306. This is done to verify that the participant is actually part of that organization and that information for that participant already exists.

In step 506, after the participant has been verified as a member of the organization, the participant fills out login information such as a user name and password, and then completes a personal investment profile. The personal investment profile in one embodiment is a seventeen (17) question multiple choice quiz which is used to evaluate the conservative or aggressive nature of the participant in regards to the participant's investment strategies and beliefs. After answering the questions, the particular answers to these questions are scored and accumulated and the total is used to generate a number between, in one embodiment, 100 and 500, with less than 200 being a conservative investor, between 200 and 400 is balanced and greater than 400 is a more aggressive investor. The questions include what type of return the individual is looking for, the age of the investor, when the investor plans on retiring and the like. While a specific way to implement a personal investment portfolio has been described, any way to quantify the risk aversion of an individual could be used.

Once the personal investment profile is scored and a numerical value is assigned to an individual, the forms that are required to give the facilitator permission to make trades for the participant are provided for the participant. The participant can print these forms, sign them and mail them back to the facilitator. In this step the participant can choose to use the facilitator as his or hers broker/dealer for financial transactions or enter the name and contact information for another broker/dealer. The processes involved in the end user activation process are tracked by the facilitator system and are stored in a database for compliance and client tracking.

Accessing the System

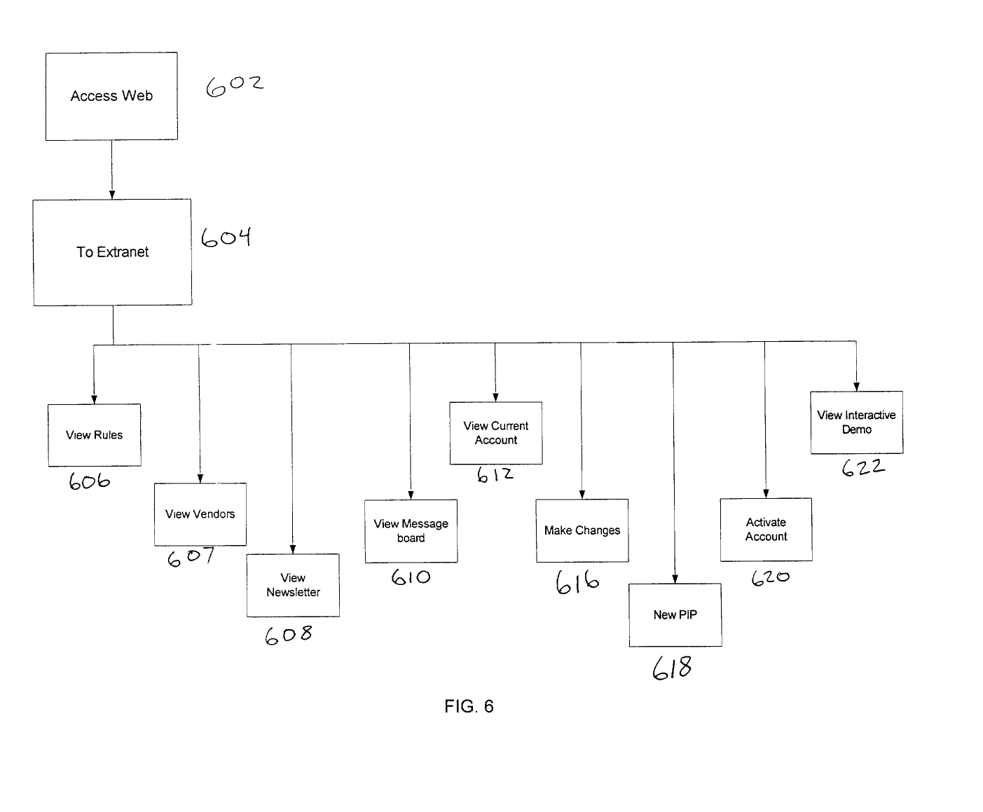

After all initial data is loaded into the system and participants are activated, the individual participants can log in to the investment system. FIG. 6 is a flow chart illustrating the use of the investment system. In step 602, the participant accesses the investment web site 118. The user is asked to identify the type of organization he or she works for, such as a school district or hospital, the state where the organization is located, and the name of the organization. After all of this information is acquired, in step 604, the participant is directed to the selected organization's extranet. The extranet is built and maintained by the facilitator and typically lists the following main choices: view investment rules (such as 403(b) rules), view approved providers, view newsletter, view message board, view your account, make changes to your account, activate an account, and try interactive demo.

If the participant chooses view investment rules (such as 403(b) rules) then, in step 606, an informational page is displayed listing all the rules for the investment plan specific to the participant's organization, such as a 403(b) plan.

If the participant chooses to view the list of approved providers then, in step 607, a list of approved financial providers for the particular organization is listed along with contact information for those providers.

If the participant chooses to view the newsletter, then, in step 608, the newsletter for the organization is provided. The newsletter may have information such as changes in providers, articles regarding retirement strategies and the like. The content of the newsletter is determined by the participant's organization and is typically supplied by the organization for posting on the investment website.

If the participant chooses to view the message board, then in step 610, a message board is displayed listing various topics and responses to those topics. The participant is able to start a new topic or reply to an already existing topic. Topics are typically organized by subject and response. The design and maintenance of the message boards is well known by Internet web page designers.

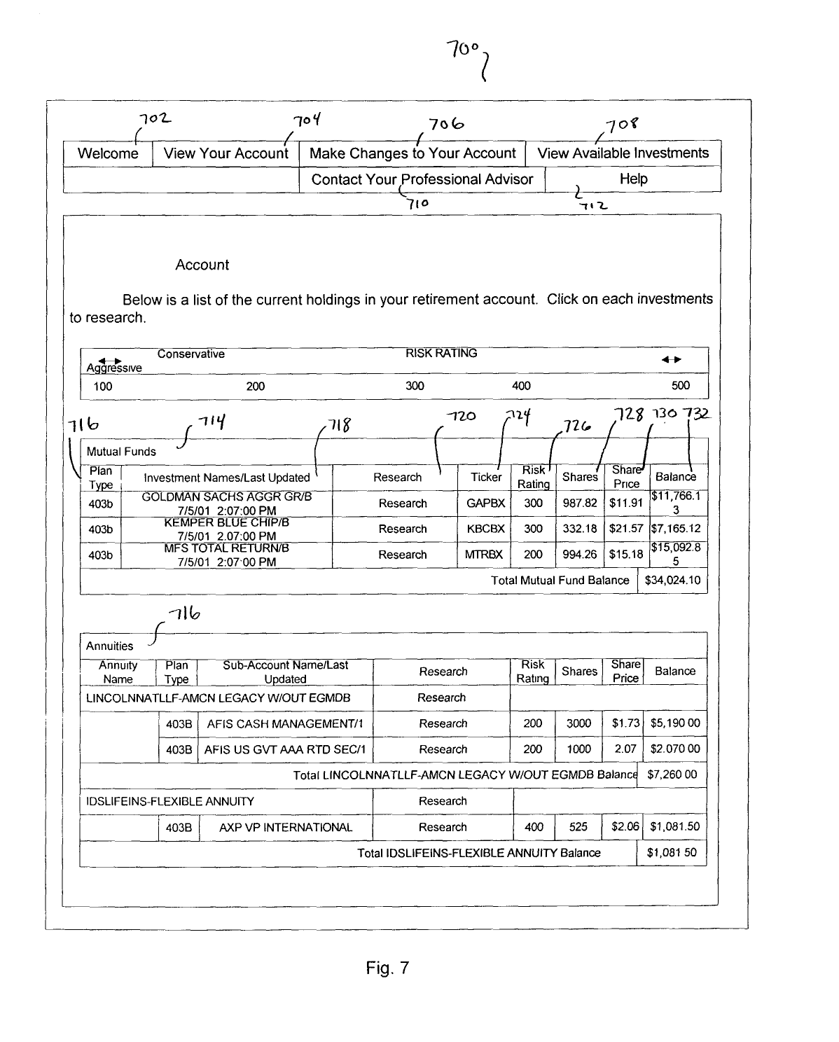

If the participant chooses view current account, then in step 612, the current account screen is displayed. FIG. 7 is an exemplary current account screen 700. At the top of FIG. 7 is a navigational bar with a series of buttons including welcome button 702, view your account button 704, which should be highlighted since it is the current bar selected, make changes to your account button 706, view available investment button 708, contact your professional advisor button 710, and help button 712.

If welcome button 702 is chosen, a rolled up account view containing mutual fund values and annuity values for the participant along with a menu, is displayed. If the view account button 704 is selected, then the current page is re-displayed. If the make changes to your account button 706 is selected, then the make changes to your account page is displayed. The functionality of this box will be presented later. If view available investment button is chosen, a list of all available investment vehicles from each investment provider is displayed. Choosing contact your financial professional button 710 brings up an email form that allows questions to be entered which are then sent to investment professionals. Choosing the help button 712 opens up a window display and help topics. The help can be context sensitive.

Account view page 700 also lists the participant's current holdings in their retirement account, typically in tabular form. The investment type 714 is listed. This distinguishes the investment listings between mutual funds and annuities. Plan type column 716 lists the type of plan that the investments are held within. In the present invention this will typically be a 403(b) plan although other plans can be used. Investment name column 718 lists the name of the mutual fund or the annuity and when the information concerning that mutual fund or annuity was last updated. Research column 720 allows a participant to select the word research in the same row as a mutual fund or an annuity of interest. This will bring up research information on a mutual fund or an annuity including information such as historical performance. Ticker column 724 lists the ticker symbol for the fund or annuity.

Risk rating 726 lists the assigned risk value of the fund or annuity. The risk rating is based on the aggressive or conservative nature of the investments within the fund or annuity. This number is assigned by the facilitator and, in one embodiment, is based on the scale of 100 to 500 with 100 being most conservative and 500 being most aggressive. The risk rating is typically updated monthly as discussed in conjunction with FIG. 4. This is the same scale used to score the personal investment profile discussed earlier. Shares column 728, lists the number of shares owned in a particular mutual fund or annuity. Share price 730, lists the present share price of the mutual fund or annuity. Therefore, balance 732 is the total amount of money invested in a particular fund or annuity. Balance 732 is equal to the number of shares multiplied by the price per share.

Turning back to FIG. 6, if the participant chooses make changes to your account, then in step 614 a login screen is displayed. After a successful login, the make changes to account screen 616 is provided which gives the choices of changing existing investments, changing future deposits, creating a new personal investment profile, or reviewing the latest personal investment profile. Changing the existing investments, involves making changes to the allocations of money among investment vehicles for money that is already invested. Changing the future deposits includes making changes to future money that will be paid by the participant, typically through deductions from the participant's paycheck. Selecting create a new personal investment profile will administer a new personal investment profile test and calculate a new personal investment profile. Reviewing your last personal investment profile involves having the latest investment profile reviewed showing the questions as well as the participant's answers to those questions.

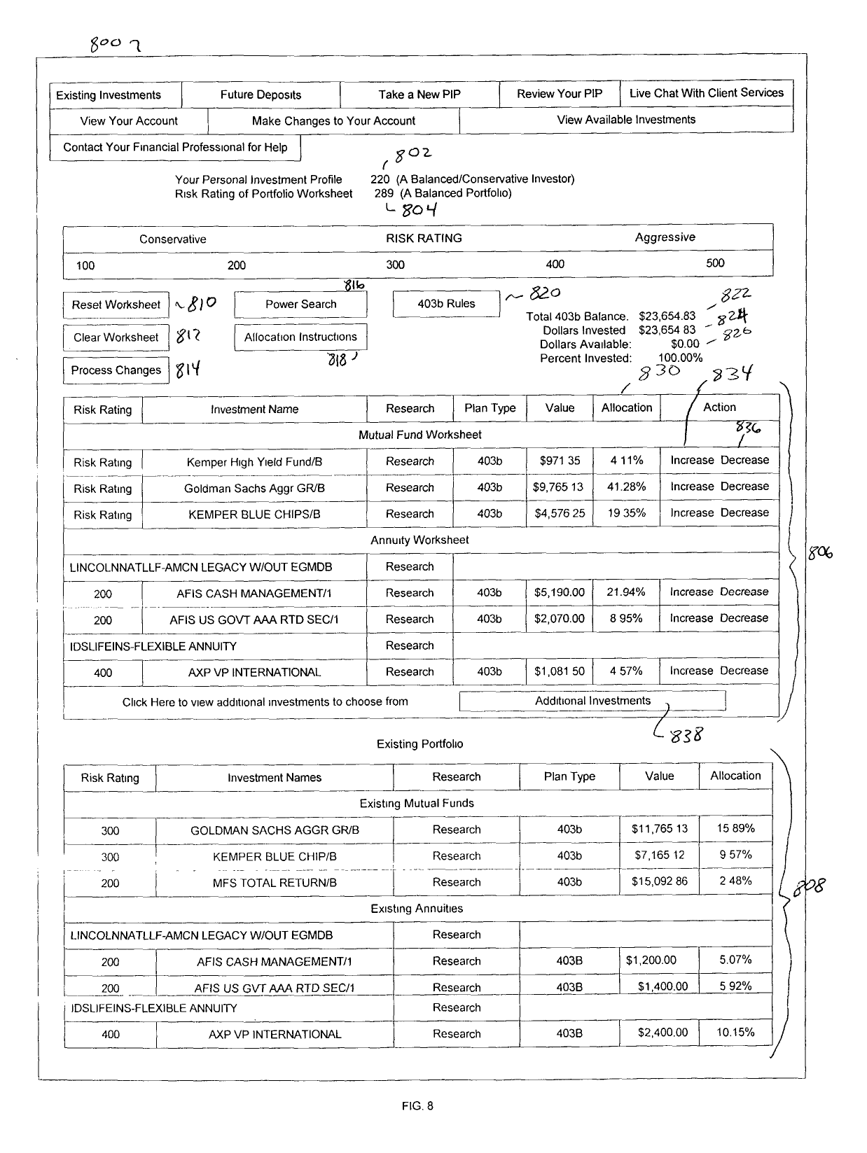

If the participant selects change existing investments, then in FIG. 8 a change existing investments page 800 is displayed. The change existing investment page 800 displays the participant's investment profile number 802, risk rating of the existing portfolio 804, as well as a worksheet 806 and a copy of the existing portfolio 808. Worksheet 806 includes a reset worksheet button 810, a clear worksheet button 812, a process change button 814, a power search button 816, allocate instruction button 818, an investment rule button 820, a total balance statement 822, a total dollars invested 824, dollars available button 826, and the percent invested 828. Again, initially the funds and annuities that the participant currently has money invested in are shown in the worksheet in a tabular form. Additional columns in this view are the view in FIG. 6 includes an allocation column 830 which lists the percent of the total amount invested allocated to each investment vehicle. An action column having two buttons indicating increase and decrease is also provided. The increase button 834 increases the allocation to that investment fund, while the decrease button decreases the allocation to that fund. This allocation can be done in terms of dollar amount or percentage. Of course, before any fund can have an allocation increased, there must be a corresponding decrease in another fund in order to make money available to have the change. Additional investment button 838 is also provided to allow the participant to choose additional investment vehicles in which to invest his money.

A participant using the change existing investment page 800 may choose additional investment button 838 to search through a list of additional investment vehicles. The investment vehicles displayed will be roughly within the range of the participant's personal investment profile. The additional investment vehicles that are shown when additional investment button 838 is selected will also include research buttons so that they can be researched by the participant. If the participant finds an additional investment vehicle that he or she likes, he or she can select it and add it to his or her worksheet as shown on the worksheet 806. In order to allocate money to the new investment, other investments have to be chosen to have a decrease made and then the increase funneled into the new investment or allocated amongst the investments already owned. Reset worksheet button 810 resets the worksheet back to the original existing worksheet as shown in the existing worksheet 808. Clear worksheet button 812 gives a blank worksheet with no current investment shown. Power search 816 button allows the participant to display multiple investment vehicles side by side to compare them based on performance information such as historical yield. Allocation instruction button 818, when chosen, displays how to manipulate the worksheet to increase and decrease funds within the worksheet. Investment rules button 820 (such as 403(b) rules button), when selected, displays the investment rules specific to the participant's organization plan, such as a 403(b) plan. Total balance statement 822 lists the total balance invested in the investment plan, such as the 403(b) plan. Dollars invested 824 lists the current dollar amount that is invested. Dollars available 826 is the difference between how much is in the fund and how many dollars is invested, which indicates how many dollars can be allocated to a new investment vehicle or put into an existing investment vehicle. Percent invested is simply the dollars invested divided by the total 403(b) balance expressed as a percentage. As before, the worksheet includes research buttons such that when selected, information concerning the investment vehicle can be displayed.

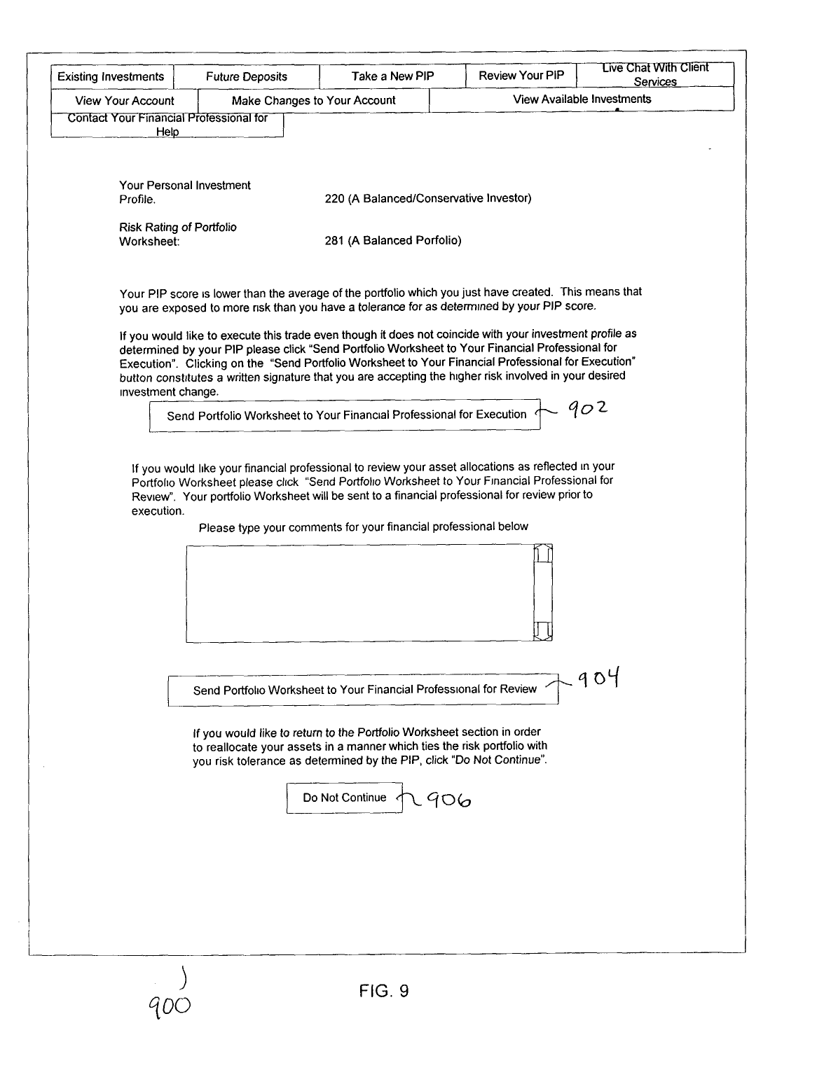

Once a participant has gone through a worksheet and has changed allocations amongst existing funds, or has decided to buy into a new fund by adding additional investments, the participant can select the process change button 814. This brings up process change screen 900 as seen in FIG. 9. Process change screen 900 first shows a comparison between the participants' personal investment profile and the risk rating of the portfolio. If there is a significant difference between the personal investment profile of the participant and the risk rating of the portfolio worksheet, then a note is made on process change screen 900 indicating that the portfolio risk rating is different then the personal investment profile and would the participant like to continue. This provides a check for the participant. The participant may select a send portfolio worksheet to financial professional for execution button 902, or the participant may type in comments to a financial professional and select the send portfolio worksheet to financial professional for review button 904. By selecting review button 904, the worksheet and any comments are sent to a financial professional for their analysis and a return email is sent to participant. At that time, the changes are not made. If the execution button 902 is selected, then that change information is sent to the broker for changes. Also, any necessary forms needed to make those investment changes will be provided to be printed out by the participant. In the case of horizontal trades, where money is being switched from one investment family of funds to another, the option of placing the money into a money market account before total execution of the trade is given. Also shown in change of investment screen 900 is a do not continue button 906 which allows participant to go back to the worksheet and affect changes.

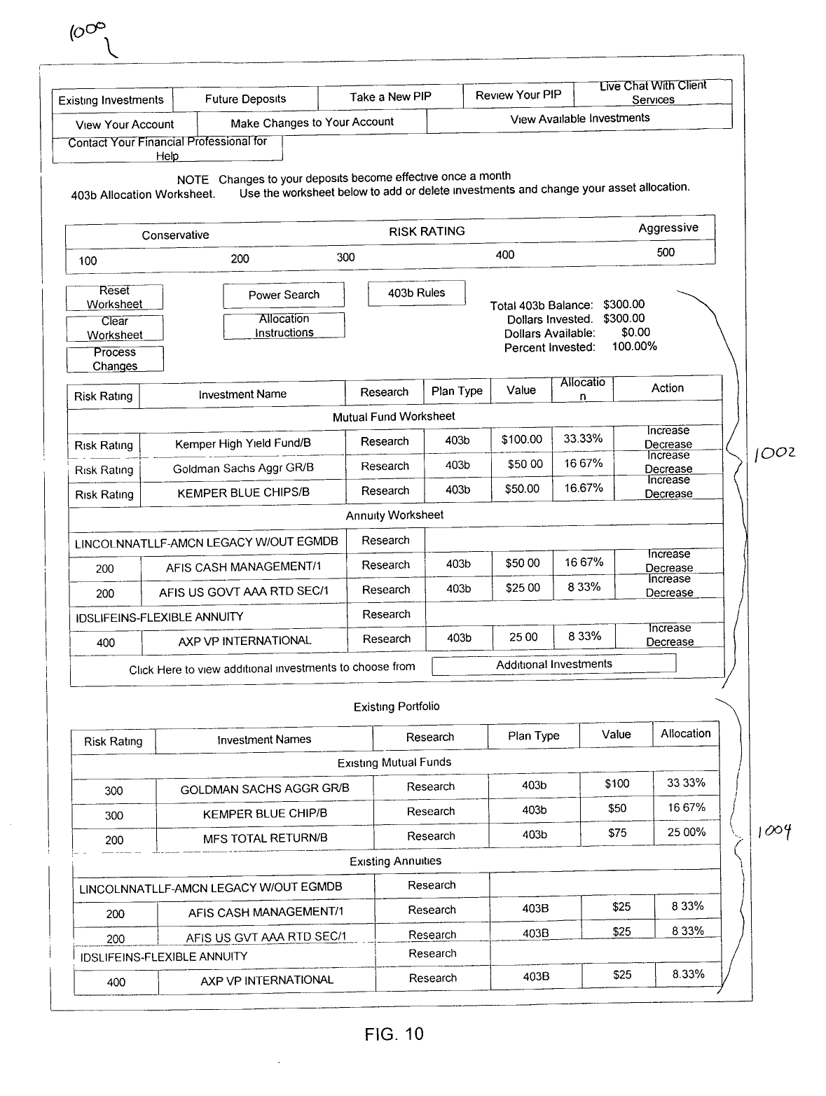

If the participant selects change future allocations, then a future allocations screen 1000 is provided as seen in FIG. 10. Future allocations screen 1000 includes a future allocation worksheet 1002 and existing allocation table 1004. The main difference between changing existing allocations and changing future allocations is that changing future allocations changes the money that is to be removed from future paychecks and changing where that money goes to in terms of which funds and annuities. Again, an investor may add new investments by selecting the show investment button 1006 or may increase or decrease allocations by selecting increase button 1008 or decrease button 1010. The other buttons work similarly to the buttons in FIG. 9.

Turning back to FIG. 6, in FIG. 6 if the participant chooses to take a new personal investment profile, then in step 618, a new personal investment profile quiz is displayed and the participant can take the quiz and can get scored with a new personal investment profile score.

Also in FIG. 6, if the participant chooses to activate an account, then in step 620, the new account activation screen is displayed as was discussed in conjunction with FIG. 6.

Selecting trying interactive demo brings up, in step 622, an interactive demo that allows a user to use the system in order to learn how to best utilize the capabilities of the system.

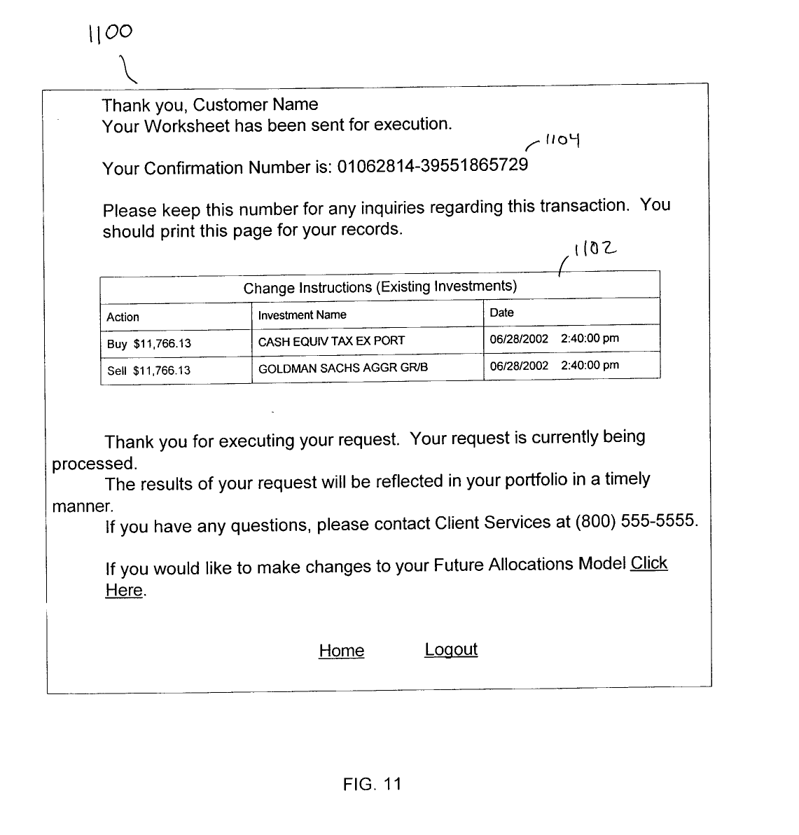

FIG. 11 is an exemplary confirmation screen 100. This screen includes a change section 1102 that lists the latest changes made to a users investment portfolio. Also included is a confirmation number section 1104 for listing a confirmation number generated for any changes made to a user's account. This number can be used to track the transaction changes.

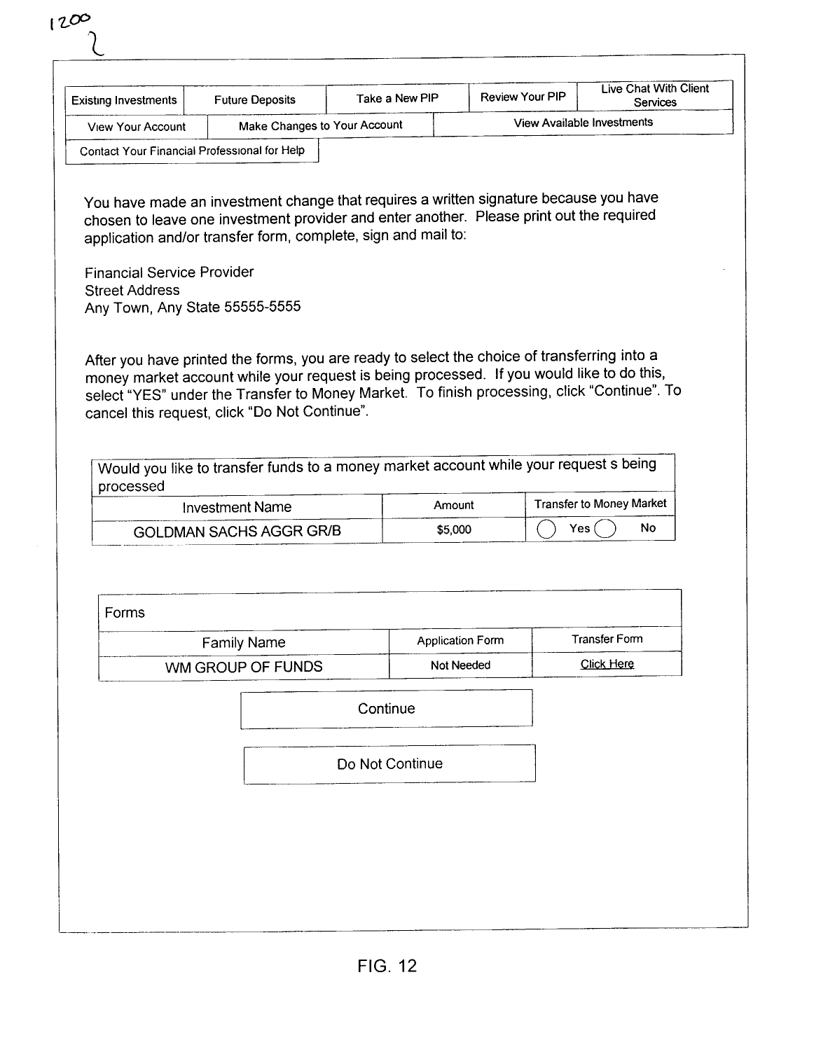

FIG. 12 is an exemplary horizontal change screen. Horizontal change screen 1200 is displayed when an investor leaves the investment vehicles of one provider of investment vehicles and buys into one or more investment vehicles of a provider not previously used by the participant. Any necessary transfer or application fund can be printed from this page and signed by the participant. The participant can also select to have the money to be invested sent to a money market account awaiting the approval of the transaction.

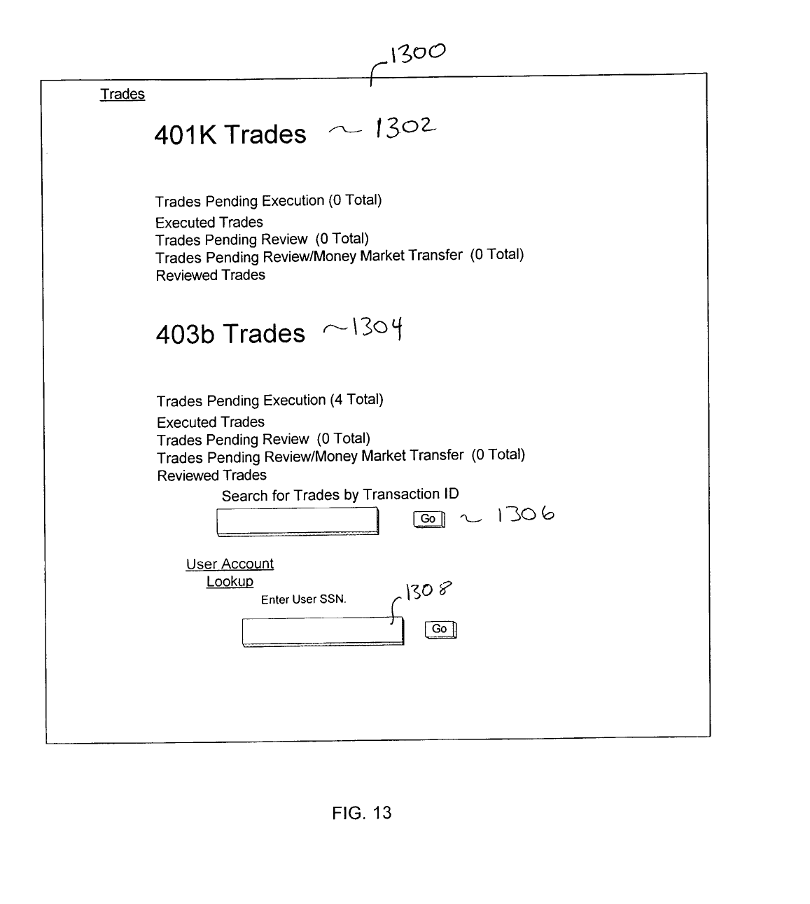

FIG. 13 is an exemplary pending trade screen 1300. This screen can be used by a user to check pending trades and recently executed trades. Typically, pending trade screen 1300 will include sections for each type of investment. For example, in FIG. 13 there is a 401k trade section 1302 and a 403(b) trade section 1304. Each lists selectable links to view information such as trades pending execution, recently executed trades, trades pending review, trades pending market money transfer and reviewed trades. Also included may be the capability to search for a trade by transaction or confirmation ID using the ID search box 1306. A user could also locate his/her account by using user search box 1308. User search box 1308 typically allows for a search by social security number although other parameters such as name or an assigned chosen identification number.

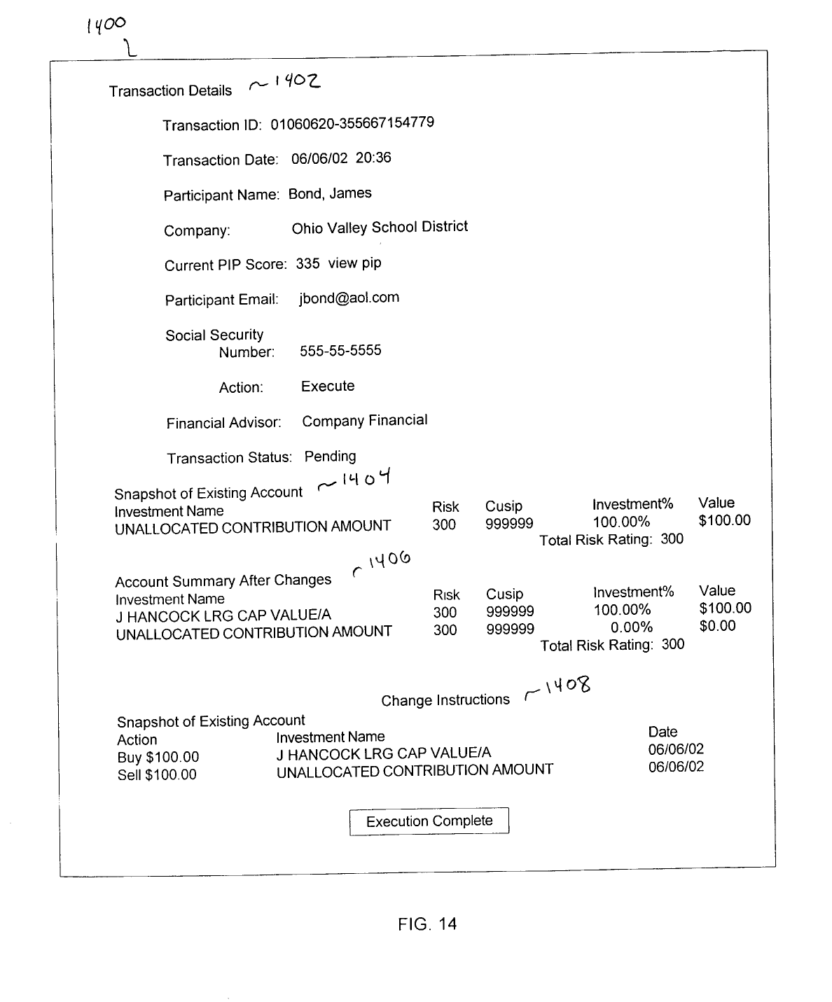

FIG. 14 is an exemplary transaction summary screen 1400. Transaction summary screen 1400 may include a transaction detail section 1402, an existing account section 1404, an account summary change section 1406 and a change instruction section 1408.

Transaction detail section 1402 may list information such as transaction ID, transaction name, user name, company, user PIN, user social security number and the like.

Existing account section 1404 shows existing allocations. Account summary change section 1406, show any changes, additions, removals and modifications to an investment profile. Change instructions section 1408 shows changes made and the date changes were made.

Professional Choice

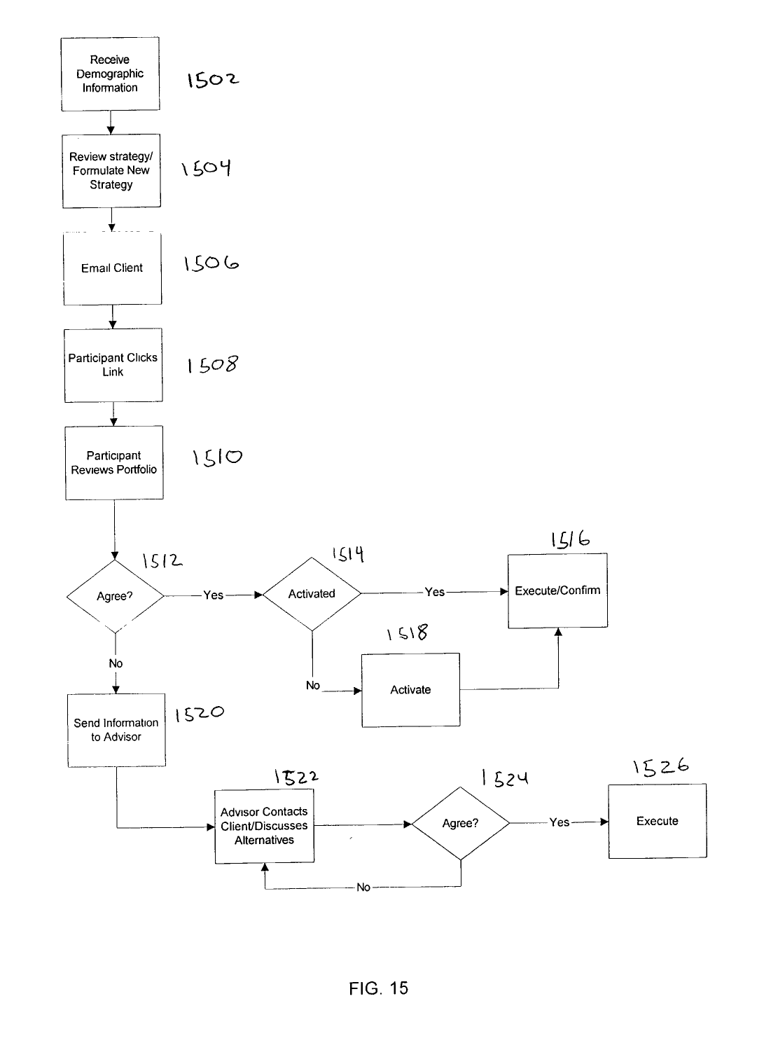

FIG. 15 is a flow chart illustrating the professional choice module of the present invention. The professional choice module allows a professional investment advisor to view either an existing portfolio and suggest changes or to suggest investments if the participant has no existing portfolio. In step 1502, the facilitator receives the initial demographic information. This will include information regarding all eligible participants in an investment plan whether or not they are currently participating in a plan. The information may be as simple as the participant's name, address and email address. If the participant is already active in the organizations investment plan the information may include the amount of money already invested as well as the amount of money allocated per month or pay period. The amount of information depends on what information is available.

After the demographic information is received for each participant, a financial advisor reviews the participants' current investment portfolio in step 1504. Based on the participants' current investment portfolio the financial advisor formulates a proposed new investment portfolio. If the participant does not have an existing investment portfolio, the financial advisor can suggest a model investment portfolio with suggested monthly contributions. In some cases the model investment portfolio may include a number of investment vehicles with detailed allocation. In other cases, only a small number of funds or types of funds may be suggested. The choice is based on the information the financial advisor has concerning the individual as well as the judgment of the financial advisor.

In step 1506, the proposed portfolio is emailed to the client. The email would include an introductory message and, in one embodiment, a link to where the model investment portfolio can be accessed. The model investment portfolio can also be included with the email. However, by forcing the participant to link to the web site to view the model investment portfolio, the facilitator has a better chance of getting the participant to activate an account if the participant has not previously enrolled. While typically the proposed investment portfolio will be emailed to the client, the information could also be mailed or faxed to a client with a description of how to access the model portfolio.

In step 1508 the client reads the email and links into the facilitator's web site. If the client does not link to the facilitator's web site after a certain amount of time after the email has been sent, the financial advisor can attempt to contact the client via email, the phone, regular mail or a fax. In step 1510, the client reviews the proposed model investment portfolio. Again, the client can perform research on any of the investment vehicles in the proposed investment portfolio. Also, the clients' existing investment portfolio, if any, can be viewed. In step 1512 it is determined if the user agrees with the proposed model investment portfolio.

If the client agrees, in step 1514 it is determined if the client is already activated (enrolled) at the web site. If the client has previously enrolled, the trade is executed and any necessary forms are sent to the client as previously discussed 1516. The client receives a confirmation number and the change instruction is sent to the facilitator for execution. If the client was not enrolled, then, in step 1518, the client completes the enrollment process, as described in conjunction with FIG. 5.

If, in step 1512, the client does not accept the model portfolio, in step 1520, information is sent to the financial advisor indicating such non-acceptance. Also, the client is able to send text messages that ask questions or address concerns about the portfolio. The financial advisor is then able, in step 1522, to contact the client to discuss the model portfolio and alternatives. Then, in step 1524, it is determined if there is now agreement with the advisor's suggestions. If so, in step 1526, the changes are executed with a confirmation number issued. If there is no agreement, then the process can return to step 1524 for further discussions.

Throughout the process, the email and other electronic conversations are logged and stored. They can also be searched at a later time to ensure the financial advisor is not making statements that guarantee specific performance or in any way violates any rules or regulations regarding investing and investment advice.

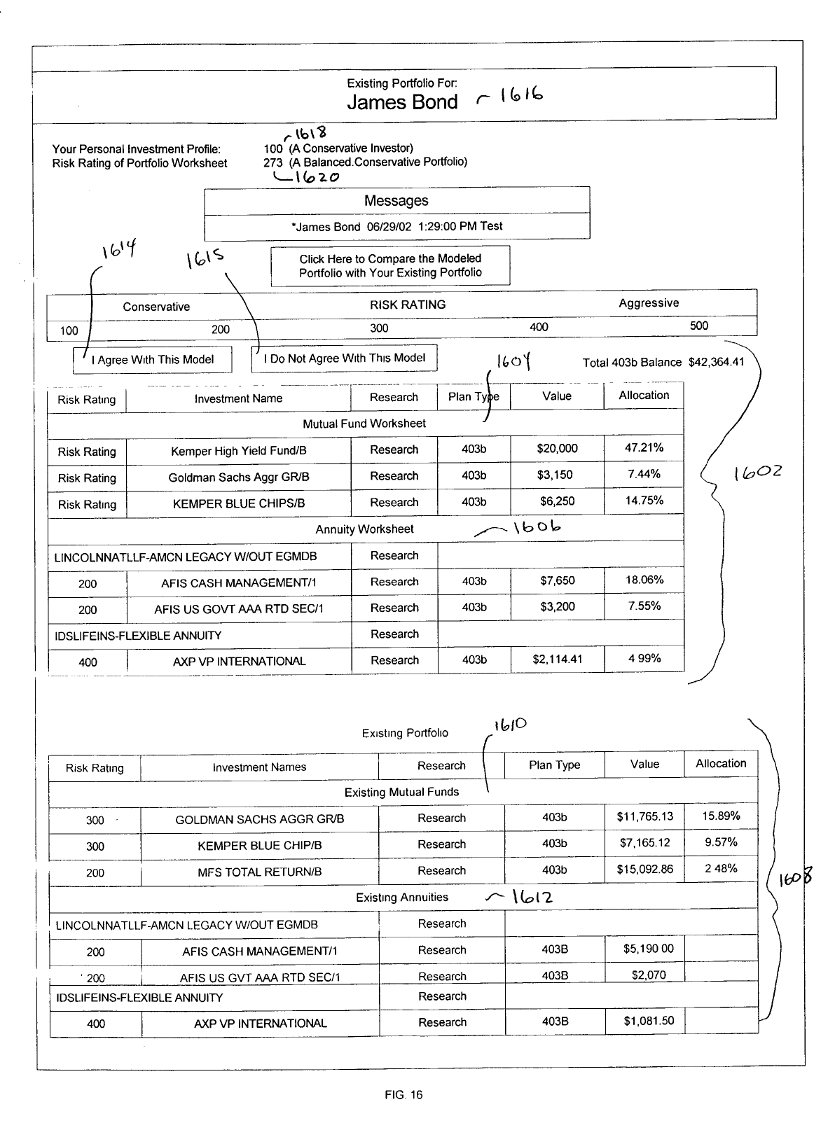

FIG. 16 is a proposed worksheet such as a worksheet proposed by a professional choice advisor. The worksheet contains both a proposed investment section 1602 and an existing portfolio section 1608.

Proposed investment section 1602 may include both proposed mutual funds 1604 and proposed annuities 1606. As noted before, each investment strategy includes the name of the investment, the numerical risk of the investment, the plan type for the investment, the dollar value allocated in the investment and the present allocation for the investment per plan type. A research option is provided for allowing a user three options to change to further research any investment vehicle.

Existing portfolio section 1608 includes an existing mutual fund section 1610 listing the mutual funds currently existing for a user. An existing annuity section 1612 lists the annuity products in which the user is currently investing.

An “agree” button 1614 allows the user to agree with the proposed investment model as shown in the proposed worksheet 1602. If the user selects this button, the proposed worksheet is adopted by the user as the new investment portfolio. Also provided is a “disagree” button 1615 to decline the proposed investment model. Choosing this button maintains the status quo as it relates to investment strategy. Also provided are the investor's name 1616 as well as a measurement of the risk of the user 1618 and the risk assessment of the proposed portfolio 1620.

Proposed portfolio 1600 may be sent to a user by an investment advisor after either personally consulting with the user or examining a user's existing account. This information can be sent via email or regular mail. Alternatively, the URL or links to network sites where the information exists can be provided.

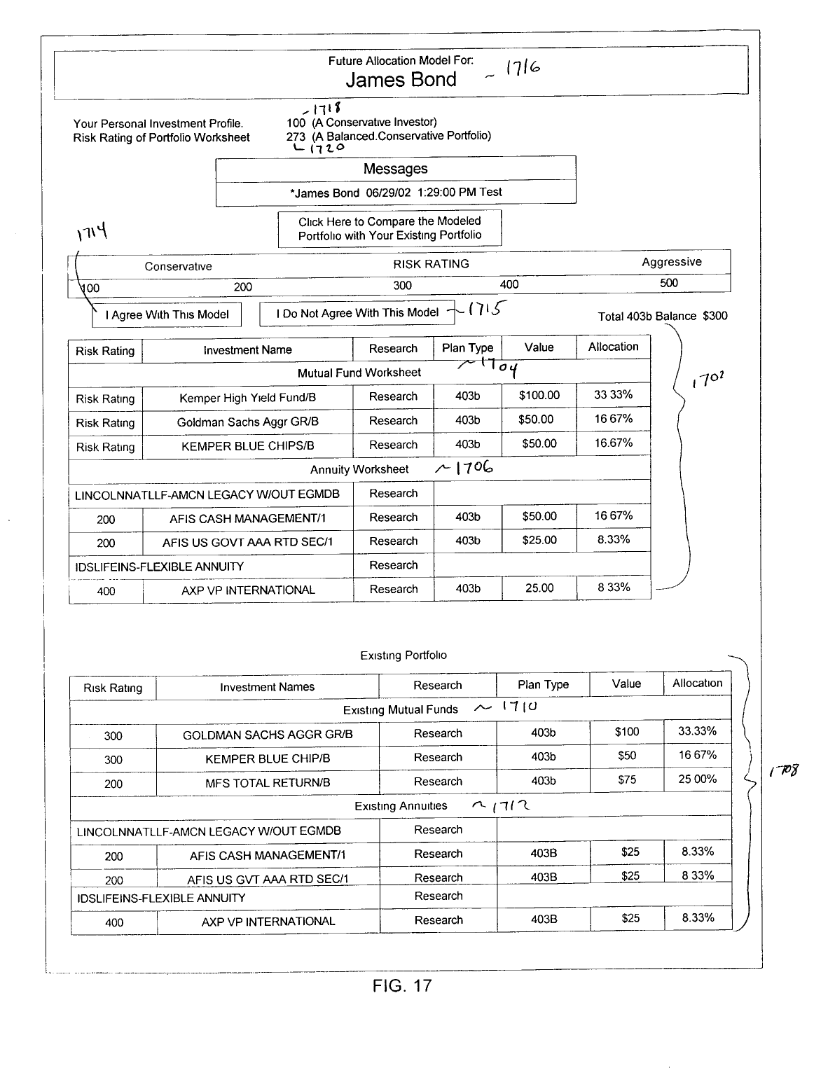

FIG. 17 is an exemplary future allocation screen 1700. This screen is used to allocate future monthly investments among a choice of mutual funds and annuities. The future allocation screen has both a proposed allocation section 1702 and an existing allocation section 1708. The difference between this screen and the screen from FIG. 16 is that this allocates future deductions from an investor's paycheck.

Proposed allocation section 1702 may include both proposed mutual funds 1704 and proposed annuities 1706. As noted before, each investment strategy includes the name of the investment, the numerical risk of the investment, the plan type for the investment, the dollar value allocated in the investment and the present allocation for the investment per plan type. A research option is provided for allowing a user three options to change to further research any investment vehicle.

Existing allocation section 1708 includes an existing mutual fund section 1710 listing the mutual funds currently existing for a user. An existing annuity section 1712 lists the annuity products in which the user is currently investing.

An “agree” button 1714 allows the user to agree with the proposed investment model as shown in the proposed worksheet 1702. If the user selects this button, the proposed worksheet is adopted by the user as the new investment portfolio. Also provided is a “disagree” button 1715 to decline the proposed investment model. Choosing this button maintains the status quo as it relates to investment strategy. Also provided are the investor's name 1716 as well as a measurement of the risk of the user 1718 and the risk assessment of the proposed portfolio 1720.

Proposed future allocation 1700 may be sent to a user by an investment advisor after either personally consulting with the user or examining a user's existing account. This information can be sent via email or regular mail. Alternatively, the URL or links to network sites where the information exists can be provided.

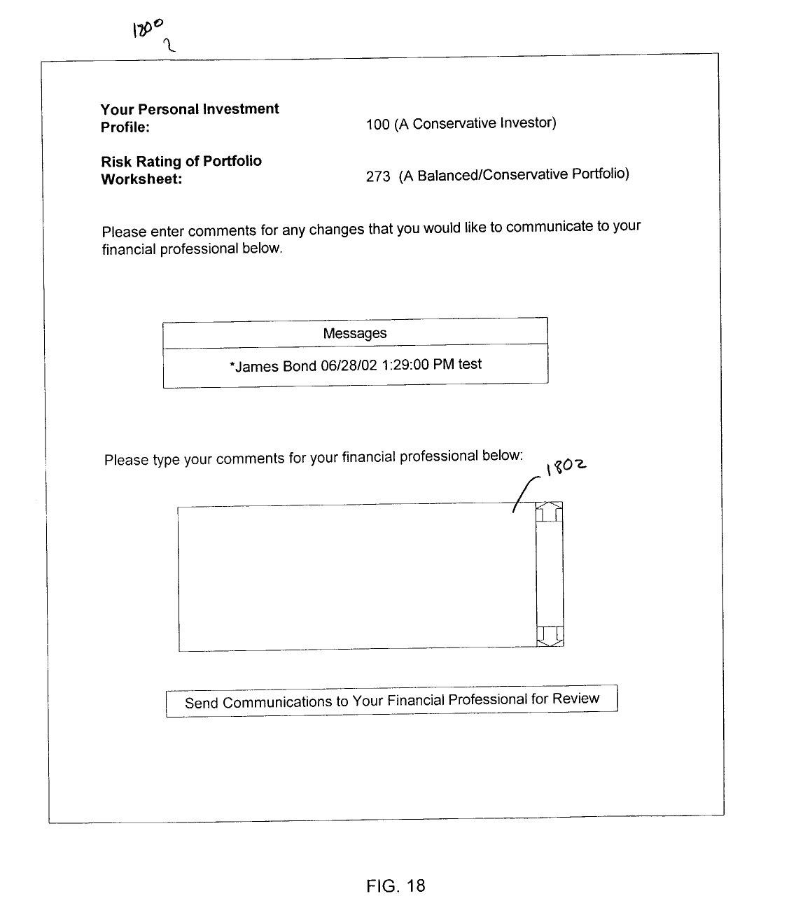

FIG. 18 is a send message screen 1800. It provides a message box 1802 for entering questions or comments that will be sent to the financial advisor. In one embodiment this screen is reached by a user upon rejection of the proposed portfolio of FIG. 16 or if the user had questions regarding the proposed portfolio. All e-mails can be saved by the system for future reference.

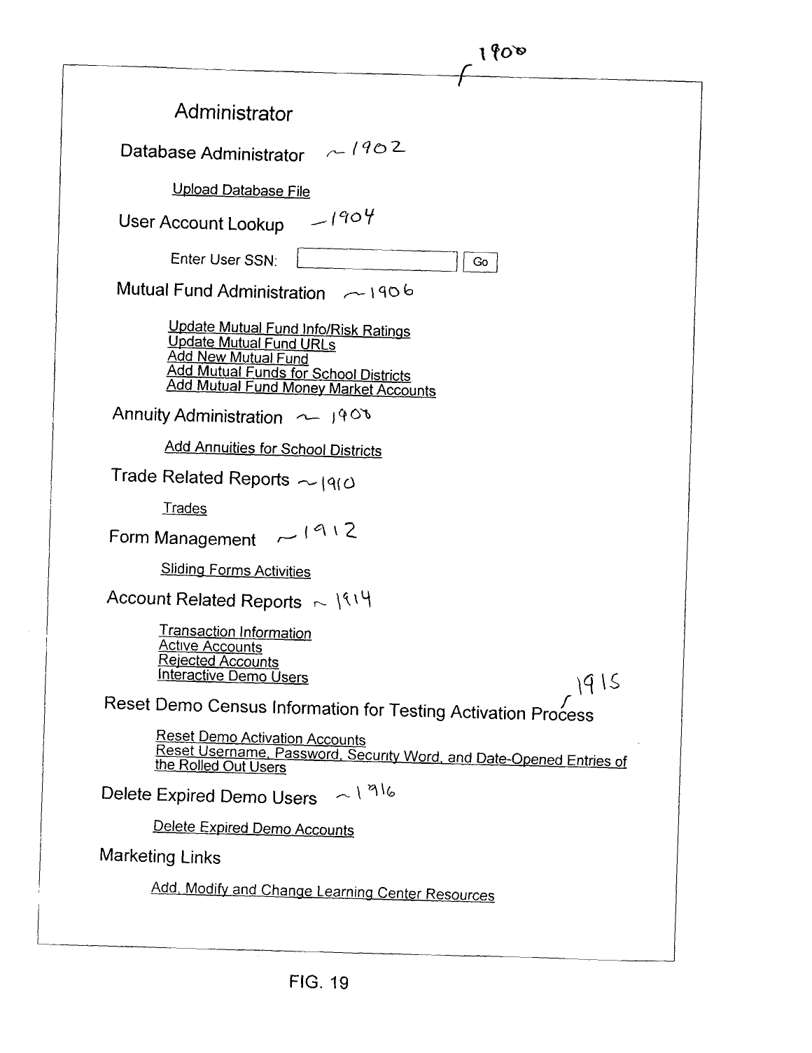

FIG. 19 is an exemplary administrative screen 1900. This screen allows those with access to perform different types of administrative work on the present invention. For example, administrative screen 1900 may have a database administration section 1902 that allows an administrator to upload database information. A user account look up section 1904 allows for a specific user account to be searched for by, in this example the user's social security number. Of course, users can be searched for by other user identification such as last name or assigned user name.

A mutual fund administration section 1906 that can be used by system administration personnel to update information such as mutual fund information/risk rating, update a mutual funds URL, which updates the location on the network where information regarding a mutual fund can be found. Other mutual fund administrative functions can include an add mutual fund section, which allows the administrator to add new network fund choices to the options, an add mutual fund for school districts choice allows mutual funds to be added to the choices for a given school district, an add all mutual fund money market accounts for adding money market accounts.

An annuity administration section 1908 includes similar choices for annuities as the mutual fund administration section.

A trade related report section 1910 provides choices for generating reports regarding trades made online by account holders. A form management section 1912 allows for the editing, addition or deletion or forms used in the present invention. An accounts related reports section 1914 allows for various reports to be generated based on transaction, active accounts, rejected accounts and the like. A delete user section 1916 can be provided for the removal of old data.

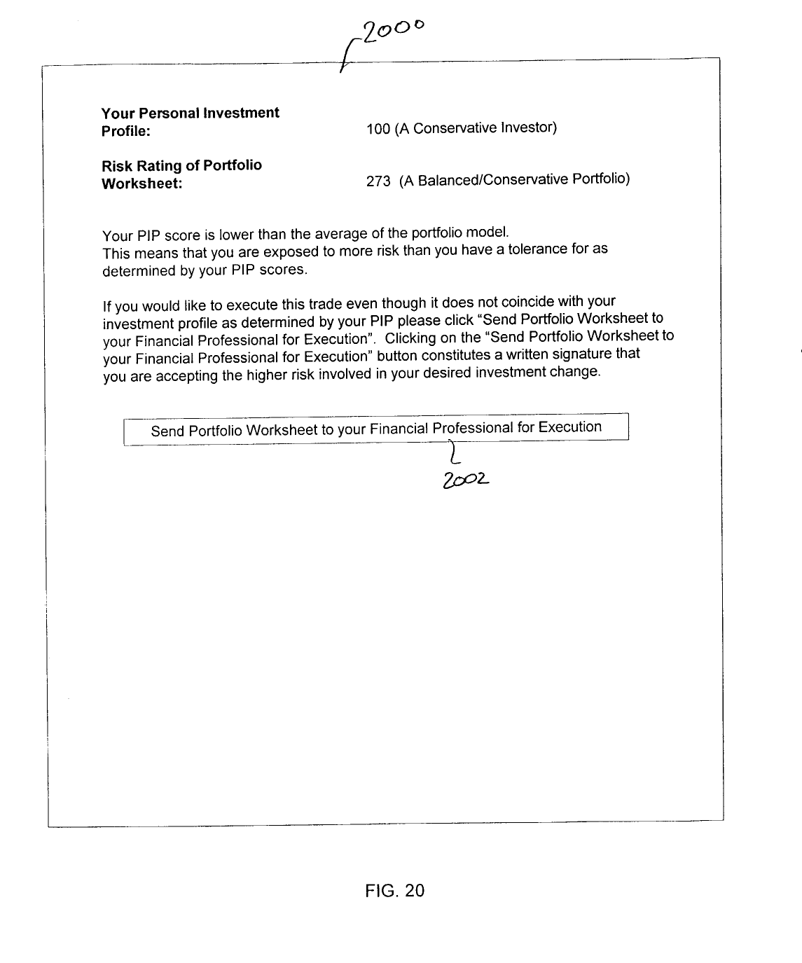

FIG. 20 is a profile warning screen 2000. This screen is programmed to appear when the selected investment profile risk factors are greater than or less than the calculated user's risk factors. Text on the profile warning screen 2000 explains that the investments are chosen either higher (more risky) or lower (less risky) than the user's predetermined personnel investment profile. If the user wishes, the user can select a proceed button 2002 to proceed with the investment portfolio chosen even though it is not in agreement with the user's personnel investment profile. If the user decides not to continue, the user can go back and reselect investments. This screen provides a check for investors to make sure they know if investment choices are outside their predetermined risk profile. Also, it provides the investment advisor with verification when a user chooses to invest outside of its predetermined risk profile. To determine the risk factor of a portfolio a weighted calculation can be used. In this embodiment the risk rating of each individual investment vehicle is multiplied by the radio of dollars allocated to that investment and the total dollar value of the portfolio. This is done for each investment vehicle and the results are summed. Any unallocated money is taken into account similarly by allocating a risk factor of 100.

Having now described preferred embodiments of the invention modifications and variations may occur to those skilled in the art. The invention is thus not limited to the preferred embodiments, but is instead set forth in the following clauses and legal equivalents thereof. While the preferred embodiments of the invention have been illustrated with the use in a 403(b) account program, the invention is not limited to just 403(b) or 403(k) programs but can be utilized in any employee sponsored or administered investment program.

What is claimed:

1. A system for facilitating investments comprising:
a computer having a processor and memory operable to:
receive demographic information concerning a participant in an investment program;
provide the demographic information to an investment advisor;
receive a proposed investment portfolio containing one or more investment vehicles from the investment advisor based on the demographic information; and
send the proposed investment portfolio to the participant.

2. The system of claim I wherein a personal investment profile is calculated for the participant to assess the risk aversion of the participant, the personal investment profile included as part of the demographic information.

3. The system of claim I wherein the computer is further operable to:
receive a request from the participant to research one or more individual investment vehicles in the proposed investment portfolio; and
send information regarding the historical performance of the proposed investment portfolio to the participant.

4. The system of claim 1 wherein the computer is operable to receive and process a request to adopt the proposed investment portfolio.

5. The system of claim 2 wherein the one or more individual investment vehicles are assigned risk values indicating the conservative/aggressive nature of the investment.

6. The system of claim 5 wherein the proposed investment portfolio is based on the risk values assigned to the one or more individual investment vehicles and the personal investment profile of the participant.

7. The system of claim 1 wherein the participant accesses the computer via the Internet.

8. The system of claim 5 wherein information regarding investment vehicles that fall within the participant's personal investment profile are sent to the participant.

9. The system of claim 1 wherein the computer is further operable to receive questions from the participant regarding investments and pass them to the investment advisor.

10. The system of claim 2 wherein the personal investment portfolio is based on answers to a multiple choice quiz.

11. The system of claim 1 wherein the proposed investment portfolio is sent via an email.

12. The system of claim 1 wherein the participant is sent a link to a web site where the proposed investment portfolio is saved.

13. The system of claim 1 wherein the proposed investment portfolio is a portfolio listing allocations of currently invested money.

14. The system of claim 1 where the proposed investment portfolio is a portfolio listing future allocations of future property.

15. The system of claim I wherein the investment plans is a 403(b) plan.

16. A method for facilitating investment comprising:
receiving census information concerning participants in an investment program;
evaluating the current investment strategy of each of the participants as disclosed in the census information;
formulating a proposed new investment portfolio comprising one or more investment vehicles for each of the participants; and
sending the portfolio to each of the participants.

17. The method of claim 16 further comprising the step of calculating a personal investment profile for each of the participants to assess the risk aversion of each of the participant, the personal investment portfolio included as part of the census information.

18. The method of claim 16 further comprising the steps of:
receiving a request to research at least one of the one or more investment vehicles in the proposed new investment portfolio; and
sending information regarding at least one of the proposed new investment portfolio.

19. The method of claim 16 further comprising the step of receiving a request to buy the proposed investment portfolio.

20. The method of claim 17 further comprising the steps of assigning a risk rating to each of the one or more investments of the investment portfolio indicating the conservative/aggressive nature each of the investment.

21. The method of claim 20 further comprising the step of allowing the participant to search a plurality of investments having a predetermined risk rating to find investments that are close to the participant's personal investment profile.

22. The method of claim 20 further comprising comparing the risk rating assigned to the investment portfolio to the personal investment profile of the participant to determine if the risk rating of the portfolio matches the personal investment profile.

23. The method of claim 22 further comprising issuing a warning if the risk value of the investment portfolio is greater than or less than the personal investment profile of the participant by a predetermined amount.

24. The method of claim 16 further comprising storing all electronic messages between the participant and a financial advisor.

25. The method of claim 24 comprising scanning the stored electronic messages to ensure conversations between the participants and the investment advisor do not violate governmental regulations.

26. A system for providing professional advice to investors comprising:
an investment advisor computer means for receiving information regarding participants in an investment plan;
an investment advisor, the investment advisor reviewing the information regarding participants in the investment plan and formulating an investment strategy; and
wherein the investment strategy is sent to the participants by the investment advisor computer means for review.

27. The system of claim 26 wherein the investment strategy is based on a risk analysis of the participant.

28. The system of claim 26 wherein the participants communicate with the investment advisor computer means via the internet.

29. The system of claim 26 wherein the participant can contact the investment advisor via email or instant messages.

30. The system of claim 29 wherein communications between the participant and the investment advisors are recorded.
